(19) United States
(12) Patent Application Publication
(10) Pub. No.: US 2009/0064988 A1
(43) Pub. Date: Mar. 12, 2009

(54) Barbecue grill

(76) Inventor: Chih-Ming Chiang, Taichung (TW)

Correspondence Address: Joe McKinney Muncy, PO Box 1364, Fairfax, VA, 22038-1364, US

(21) Appl. No.: 11/898,315

(22) Filed: Sep. 11, 2007

(51) Int. Cl. A47J 37/00

(52) U.S. Cl. 126/25 R

(57) ABSTRACT

A barbecue grill has a body, a cover and two pivots. The body has a top, an outer surface and two pivotal brackets mounted on two sides of the outer surface. The cover is pivotally connected to the top of the body and has two pivotal tabs. The pivotal tabs are attached to the cover and correspond respectively to the pivotal brackets on the body. Each pivotal tab has an elongated channel defined through the pivotal tab. The pivots extend respectively through the elongated channels in the pivotal tabs and the pivotal brackets on the body to pivotally connect the cover to the body. Accordingly, the cover is easily opened.

### BACKGROUND OF THE INVENTION

1. Field of the Invention

The present invention relates to a barbecue grill, and more particularly to a barbecue grill with a cover being easily opened.

2. Description of Related Art

With reference to FIG. 6, a conventional barbecue grill comprises a body (40) and a cover (41). The body (40) may comprise a bowl and a stand. The bowl has a bottom and a top opening. The stand is attached to the bottom of the bowl to support the bowl. The cover (41) is detachably attached the bowl to close the top opening and comprises an inner surface and a hook (42) mounted on and extending from the inner surface. When the cover (41) is removed from the top opening of the bowl, the cover (41) can be hung on the bowl with the hook (42).

However, to remove the cover (41) from the top opening of the bowl, the cover (41) must be lifted upward for a distance from the bowl. A user has to hold and bear the weight of the cover (41), so that to remove the cover (41) is laborious especially to a child or kid. Additionally, to hang the cover (41) on the body (40) with the hook (42) is inconvenient, and the cover (41) easily falls from the body (40) when an external force is applied to the cover (41).

To overcome the shortcomings, the present invention tends to provide a barbecue grill to mitigate or obviate the aforementioned problems.

### SUMMARY OF THE INVENTION

The main objective of the invention is to provide a barbecue grill with a cover being easily opened. The barbecue grill has a body, a cover and two pivots. The body has a top, an outer surface and two pivotal brackets mounted on two sides of the outer surface. The cover is pivotally connected to the top of the body and has two pivotal tabs. The pivotal tabs are attached to the cover and correspond respectively to the pivotal brackets on the body. Each pivotal tab has an elongated channel defined through the pivotal tab. The pivots extend respectively through the elongated channels in the pivotal tabs and the pivotal brackets on the body to pivotally connect the cover to the body.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a barbecue grill in accordance with the present invention;

FIG. 2 is an exploded perspective view of the barbecue grill in FIG. 1;

FIG. 3 is a side view of the barbecue grill in FIG. 1;

FIG. 4 is an operational side view of the barbecue grill in FIG. 1 showing the cover being opened;

FIG. 5 is an operational perspective view of the barbecue grill in FIG. 4 showing the cover being opened; and

FIG. 6 is a side view of a conventional barbecue grill in accordance with the prior art.

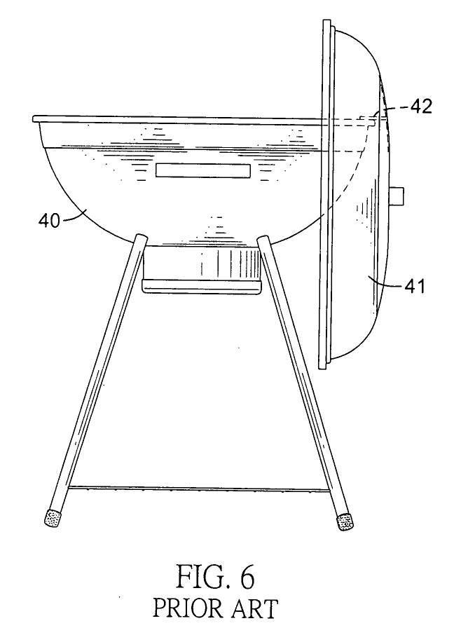

### DETAILED DESCRIPTION OF PREFERRED EMBODIMENT

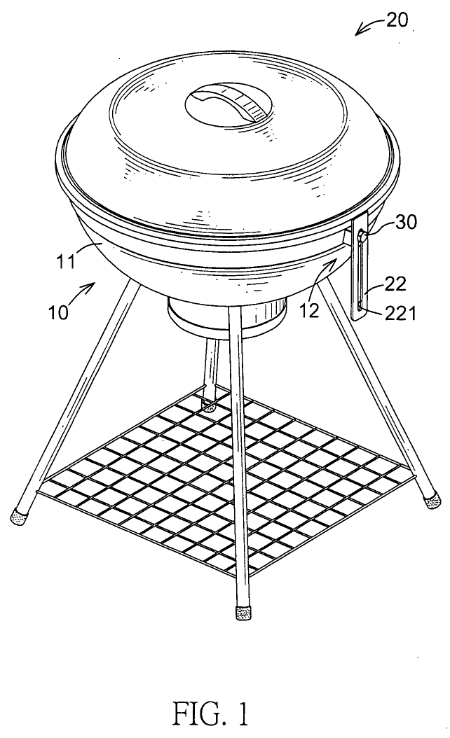

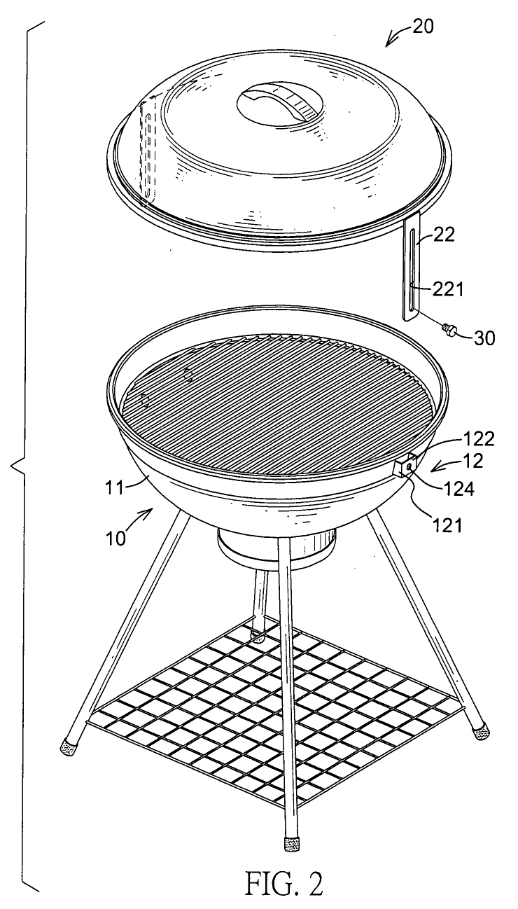

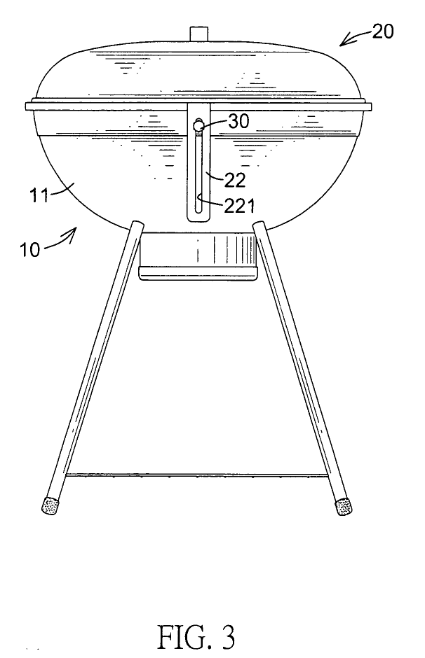

With reference to FIGS. 1 to 3, a barbecue grill in accordance with the present invention comprises a body (10), a cover (20) and two pivots (30).

The body (10) has a top, an outer surface and two pivotal brackets (12) and may be composed of a bowl (11) and a stand. The bowl (11) has a bottom and a top opening, and the stand is attached to the bottom of the bowl (11) to support the bowl. The pivotal brackets (12) are attached to two sides of the outer surface of the body (10) and are preferably attached to two sides of the opening top of the bowl (11). Each pivotal bracket (12) is U-shaped and has a middle plate (122) and two legs (121) extending from the middle plate (122) and attached to the outer surface of the body (10). The middle plate (122) of each pivotal bracket (12) may have a threaded hole (124) defined through the middle plate (122).

The cover (20) is pivotally connected to the top of the body (10) and comprises two pivotal tabs (22). The pivotal tabs (22) are attached to two sides of the cover (20) and correspond respectively to the pivotal brackets (12) on the body (10). Each pivotal tab (22) has an elongated channel (221) defined through the pivotal tab (22).

The pivots (30) extend respectively through the elongated channels (221) in the pivotal tabs (22) and the pivotal brackets (12) on the body (10) to pivotally connect the cover (20) to the body (10). In a preferred embodiment, each pivot (30) extends through and is attached to the middle plate (122) of a corresponding one of the pivotal brackets (12) and may be a bolt screwed into the threaded hole (124) in a corresponding middle plate (122). In an alternative embodiment, each pivot may be a rivet extending through the elongated channel (221) in a corresponding pivotal tab (22) and a through hole defined in the middle plate (122) of a corresponding pivotal bracket (12).

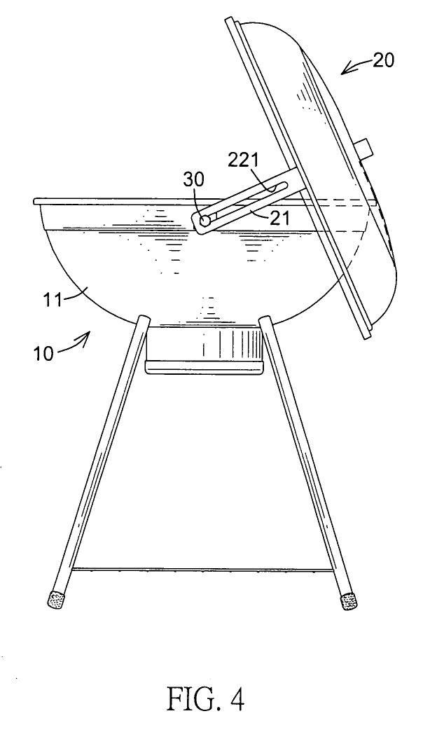

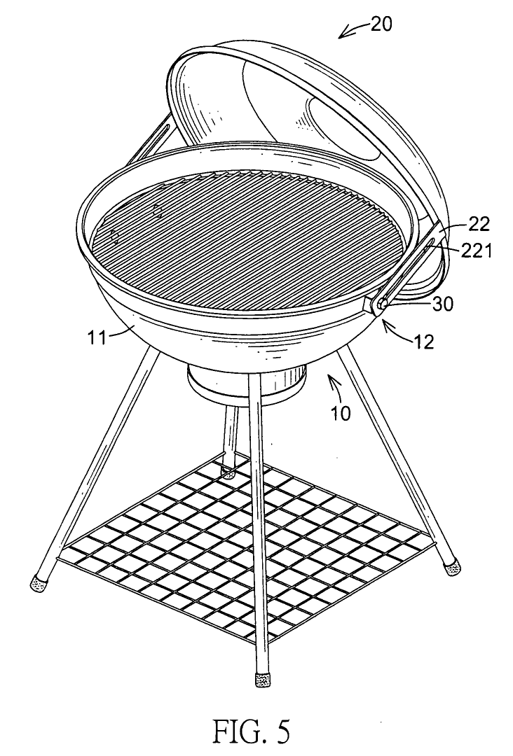

With further reference to FIGS. 4 and 5, to remove the cover (20) from the top opening of the bowl (11), the cover (20) is slightly lifted and then pivotally rotated relative to the body (10) at the pivots (30) sliding along the channels (221). Accordingly, to lift the cover (20) away from the body (10) and to hold and bear the weight of the cover (20) are unnecessary, and to remove the cover (20) from the top opening of the bowl (11) is convenient and laborsaving. Additionally, because the cover (20) is pivotally connected to the body (10) with the pivots (30), the cover (20) is undetachable from the body (10) such that the cover (20) is not fallen from the body (10) even when an external force being applied to the cover (20).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A barbecue grill comprising:
a body having a top, an outer surface and two pivotal brackets mounted on two sides of the outer surface;
a cover pivotally connected to the top of the body and comprising
two pivotal tabs attached to the cover and corresponding respectively to the pivotal brackets on the body, and each pivotal tab having an elongated channel defined through the pivotal tab; and
two pivots extending respectively through the elongated channels in the pivotal tabs and the pivotal brackets on the body to pivotally connect the cover to the body.

2. The barbecue grill as claimed in claim 1, wherein
each pivotal bracket is U-shaped and has a middle plate and two legs extending from the middle plate and attached to the outer surface of the body; and
each pivot extends through and is attached to the middle plate of a corresponding one of the pivotal brackets.

3. The barbecue grill as claimed in claim 2, wherein
the middle plate of each pivotal bracket has a threaded hole defined through the middle plate; and
each pivot is a bolt screwed into the threaded hole in a corresponding middle plate.

4. The barbecue grill as claimed in claim 3, wherein
the body is composed of
a bowl having a bottom and a top opening; and
a stand attached to the bottom of the bowl to support the bowl; and
the pivotal brackets are attached to two sides of the top opening of the bowl.

5. The barbecue grill as claimed in claim 1, wherein
the body is composed of
a bowl having a bottom and a top opening; and
a stand attached to the bottom of the bowl to support the bowl; and
the pivotal brackets are attached to two sides of the top opening of the bowl.
